(19) United States
(12) Patent Application Publication
(10) Pub. No.: US 2013/0227101 A1
(43) Pub. Date: Aug. 29, 2013

(54) Method and system for providing transaction management in a request-oriented service architecture

(71) Applicant: Ira Stevens, Quakertown, PA (US)

(72) Inventor: Ira Stevens, Quakertown, PA (US)

(73) Assignee: Verizon Patent and Licensing, Inc., Basking Ridge, NJ (US)

(21) Appl. No.: 13/405,782

(22) Filed: Feb. 27, 2012

(51) Int. Cl. G06F 15/173; G06F 17/30

(52) U.S. Cl. 709/223

(57) ABSTRACT

An approach for providing a request-oriented service architecture is described. A request, from an originating resource manager, specifying a feature, declaration information, and an action to be performed on the feature is determined. Contents of the request are merged with a current state of the feature to generate a transaction. The transaction is used to update the current state of the feature.

### BACKGROUND INFORMATION

Service providers are continually challenged to deliver value and convenience to consumers by providing compelling network services and advancing the underlying technologies. For example, product and service features are frequently added to network services and systems to provide consumers with additional value and convenience. When designing a system, for instance, to deploy a new product or service, developers typically create or utilize architectures that focus on actual implementation of the product or service. However, the development of any new product under this approach generally requires substantial time and effort and involves production systems that service many users at any one time, negatively affecting the overall cost, quality, and time-to-market for any new product or product feature.

Therefore, there is a need for a service architecture that is more flexible and effective in accommodating new services.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing a request-oriented service architecture, according to an exemplary embodiment;

FIG. 2 is a diagram of the components of a communication integration platform, according to an exemplary embodiment;

FIG. 3 is a diagram of interactions of a communication integration platform, according to an exemplary embodiment;

FIG. 4 is a flowchart of a process for providing a request-oriented service architecture, according to an exemplary embodiment;

FIG. 5 is a flowchart of a process for updating a current state of a feature using a request-oriented service architecture, according to an exemplary embodiment;

FIG. 6 is a diagram of a transaction database schema for a request-oriented service architecture, according to an exemplary embodiment;

FIGS. 7A and 7B are, respectively, diagrams of transaction states and profile feature states based on the occurrence of various actions, according to various exemplary embodiments;

FIG. 8 is a diagram of various components that utilize a request-oriented service architecture, according to an exemplary embodiment;

FIGS. 9A-9D are diagrams of components of a meta-model, according to various exemplary embodiments;

FIG. 10 is a diagram of a computer system that can be used to implement various exemplary embodiments; and

FIG. 11 is a diagram of a chip set that can be used to implement an embodiment of the invention.

### DESCRIPTION OF THE PREFERRED EMBODIMENT

An apparatus, method and software for providing a request-oriented service architecture are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

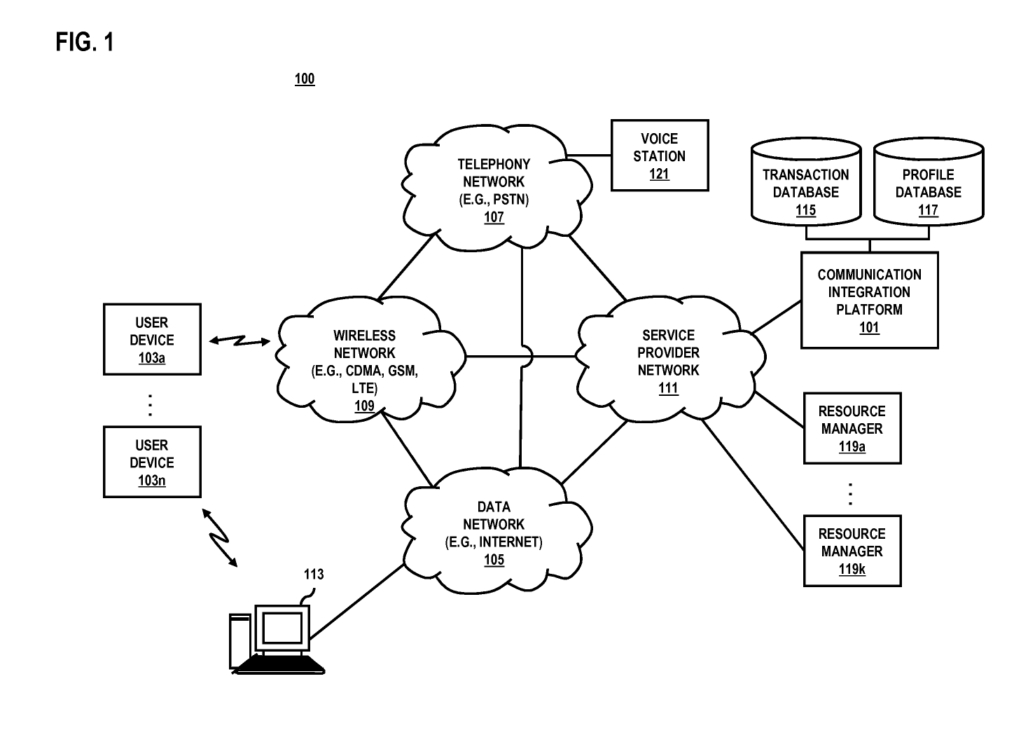

FIG. 1 is a diagram of a system capable of providing a request-oriented service architecture (ROSA), according to an exemplary embodiment. For the purpose of illustration, the system 100 employs a communication integration platform 101 that is configured to facilitate communication across disparate systems by providing a request-oriented service architecture. One or more user devices (e.g., user devices 103 (or user devices 103a-103n)) may, for instance, be utilized to initiate requests to access product and/or service features across disparate systems over one or more networks (e.g., data network 105, telephony network 107, wireless network 109, service provider network 111, etc.). According to one embodiment, service and/or product features may be included as part of managed services supplied by a service provider (e.g., a wireless communication company) as a hosted or a subscription-based service made available to users of the user devices 103 through the service provider network 111. As shown, the communication integration platform 101 may be a part of or connected to the service provider network 111. According to another embodiment, the communication integration platform 101 may be included within or connected to the user devices 103, a computing device 113, etc. While specific reference will be made thereto, it is contemplated that the system 100 may embody many forms and include multiple and/or alternative components and facilities. Communication integration platform 101, in some embodiments, can effectively reduce overall costs, decrease the time-to-market, and improve the quality for product/service features by facilitating the requests that include the concrete definitions of the product/service features based on a request-oriented service architecture.

In certain embodiments, the communication integration platform 101 may include or have access to a transaction database 115 (e.g., a long-transaction database) and an profile database 117 (e.g., a virtual enterprise state database). For example, the communication integration platform 101 may generate or update a transaction in the transaction database 115, and utilize the transactions to update product/service features in the profile database 117. In addition, in various embodiments, resource managers 119 (or resource managers 119a-119k) (e.g., event packages) may receive, for instance, a verb-noun request (e.g., initiated by a user device 103) and provide the transformation of the verb-noun request into a request that defines the behaviors and structures of the associated product/service features (e.g., such as those features that may be provided by a voice station 121) for a particular ROSA instance.

It is noted that the user devices 103 may be any type of mobile or computing terminal including a mobile handset, mobile station, mobile unit, multimedia computer, multimedia tablet, communicator, netbook, Personal Digital Assistants (PDAs), smartphone, media receiver, personal computer, workstation computer, set-top box (STB), digital video recorder (DVR), television, automobile, appliance, etc. It is also contemplated that the user devices 103 may support any type of interface for supporting the presentment or exchange of data. In addition, user devices 103 may facilitate various input means for receiving and generating information, including touch screen capability, keyboard and keypad data entry, voice-based input mechanisms, accelerometer (e.g., shaking the user device 103), and the like. Any known and future implementations of user devices 103 are applicable. It is noted that, in certain embodiments, the user devices 103 may be configured to establish peer-to-peer communication sessions with each other using a variety of technologies—i.e., near field communication (NFC), Bluetooth, infrared, etc. Also, connectivity may be provided via a wireless local area network (LAN). By way of example, a group of user devices 103 may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 103, i.e., IP addresses that are accessible to devices connected to the service provider network 111 as facilitated via a router.

As mentioned, products and product features are frequently added to network services and systems to provide consumers with additional value and convenience. New product developments typically involve disparate system integration, which generally requires a system to provide means of maintaining a long-transaction extending beyond a particular system domain, transformations between the disparate systems, a common protocol and workflow/service system framework, and a clear, concrete implementation for the actions (and their derived actions) that define the behavior of the product being developed. Developers designing a system for a new product will create or utilize architectures (e.g., service-oriented architecture) emphasizing that a server includes the concrete implementation of the product (to varying degrees) and, thus, the definition of the product's features. However, the development of any new product under this approach generally requires substantial time and effort and involves production systems that service many users at any one time, affecting the overall cost, quality, and time-to-market for any new product or product feature.

To address this issue, the system 100 of FIG. 1 introduces the capability to provide a request-oriented service architecture. With such an architecture, any new product or product feature may be pushed away from the network (e.g., server) and into the request. In one scenario, a typical verb-noun request may be initiated by a user device 103 for access to a particular product or service feature. The verb-noun request may then be received by a resource manager 119 (e.g., an event package) that provides the transformation of the verb-noun request, for instance, into a canonical form that includes the declarations (or definitions) for the particular product or service feature. The transformed request may thereafter be transmitted from the resource manager 119 to a communication integration platform 101, which may then merge the contents of the request with the current state of the feature to generate (or update) a transaction in a long-transaction database (e.g., the transaction database 115) for updating the current state of the feature (e.g., in the profile database 117). The transaction may, for instance, specify the feature, the action to be performed on the feature, the current state of the feature, the declaration information, and a current status of the transaction. Additionally, or alternatively, the transaction may specify an intended state of the feature. In particular embodiments, the request may include the minimal information necessary to create, or update, the transaction. On the other hand, the transaction may be based on the request, the current state of the feature, and other requests, for instance, to provide the explicit action and status. It is noted that, in some embodiments, the transformed request (and its children) may, for instance, be the only means of defining the structure and behavior of a product or service feature. The platform 101 may be deployed within one or more servers, and act as a broker or a facilitator of the request rather than define or maintain the new product or product feature. As such, the servers may only be required to provide very abstract services for maintaining long-transactions, providing domain integrations points, and defining the request meta-model.

In certain embodiments, the communication integration platform 101 may decompose the request (e.g., a parent request) into one or more child requests based on the declaration information. The communication integration platform 101 may further route the one or more child requests to one or more destination resource managers (e.g., compensating resource managers 119) based on the declaration information. By way of example, the declaration information may include behavior declarations and/or structure declarations for product/service features. Since the behaviors and the structures for a product/service feature are declared in the request, they may, for instance, be utilized by the communication integration platform 101 as a set of “instructions” for breaking down the request into corresponding child requests and for routing of the child requests to the various resource managers 119 to carry out respective parts of the request. It is noted that, in some embodiments, the communication integration platform 101 may also act as a compensating resource manager. For example, a child request may be destined for the communication integration platform 101 to be further decomposed into one or more grandchild requests based on the declaration information.

In one embodiment, the request may include an action to setup a conference using a conferencing feature provided by a conferencing service. Based on the declaration information, the request may then be decomposed into several child requests, for instances, including: (1) a child request that includes the necessary behavior and structure declarations for a provisioning feature for routing to a provisioning adapter that will transform the child request into instructions to provision network resources (e.g., bandwidth) for the conference; (2) a child request that includes the necessary behavior and structure declarations for the directory feature for routing to a directory adapter that will transform the child request into instructions to provide contact information of invitees for the conference; and (3) a child request that includes the necessary behavior and structure declarations for the conference feature for routing to a conference adapter that will transform the child request into instructions to utilize the provisioned network resources and the contact information to setup the conference.

In various embodiments, the communication integration platform 101 may receive one or more child responses in response to the routing of the one or more child requests. The communication integration platform 101 may further generate a parent response based on the declaration information and the one or more child responses for transmission to the originating resource manager. By way of example, the provisioning adapter, the directory adapter, and the conference adapter may respectively transmit child responses with the state “completed,” for instance, upon learning that the network resources have been provisioned, that the contact information has been provided, and that the conference has been setup based on the provisioned network sources and the contact information. As such, a parent response will be generated based on the declaration information to inform the originating resource manager (e.g., a conference event package) that the conference has been setup.

In other embodiments, the communication integration platform 101 may transmit the one or more child responses to a long-transaction database to trigger an update for the transaction in the long-transaction database, wherein the current state of the feature is updated in a profile database based on the updated transaction. In one scenario, when the child responses are respectively received from the provisioning adapter, the directory adapter, and the conference adapter with the state “completed,” the communication integration platform 101 (e.g., via the long-transaction coordinator 205) may, for instance, update the associated transaction in the long-transaction database. This may, in turn, cause an update to the current state of the feature (or features) in the profile database 117 (e.g., when the update to the transaction is detected by the virtual enterprise state manager 207).

Furthermore, the communication integration platform 101, the user devices 103, the computing device 113, the resource managers 119, the voice station 121, and other elements of the system 100 may be configured to communicate via the service provider network 111. According to certain embodiments, one or more networks, such as the data network 105, the telephony network 107, and/or the wireless network 109, may interact with the service provider network 111. The networks 105-111 may be any suitable wireline and/or wireless network, and be managed by one or more service providers. For example, the data network 105 may be any local area network (LAN), metropolitan area network (MAN), wide area network (WAN), the Internet, or any other suitable packet-switched network, such as a commercially owned, proprietary packet-switched network, such as a proprietary cable or fiber-optic network. The telephony network 107 may include a circuit-switched network, such as the public switched telephone network (PSTN), an integrated services digital network (ISDN), a private branch exchange (PBX), or other like network. Meanwhile, the wireless network 109 may employ various technologies including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like.

Although depicted as separate entities, the networks 105-111 may be completely or partially contained within one another, or may embody one or more of the aforementioned infrastructures. For instance, the service provider network 111 may embody circuit-switched and/or packet-switched networks that include facilities to provide for transport of circuit-switched and/or packet-based communications. It is further contemplated that the networks 105-111 may include components and facilities to provide for signaling and/or bearer communications between the various components or facilities of the system 100. In this manner, the networks 105-111 may embody or include portions of a signaling system 7 (SS7) network, Internet protocol multimedia subsystem (IMS), or other suitable infrastructure to support control and signaling functions.

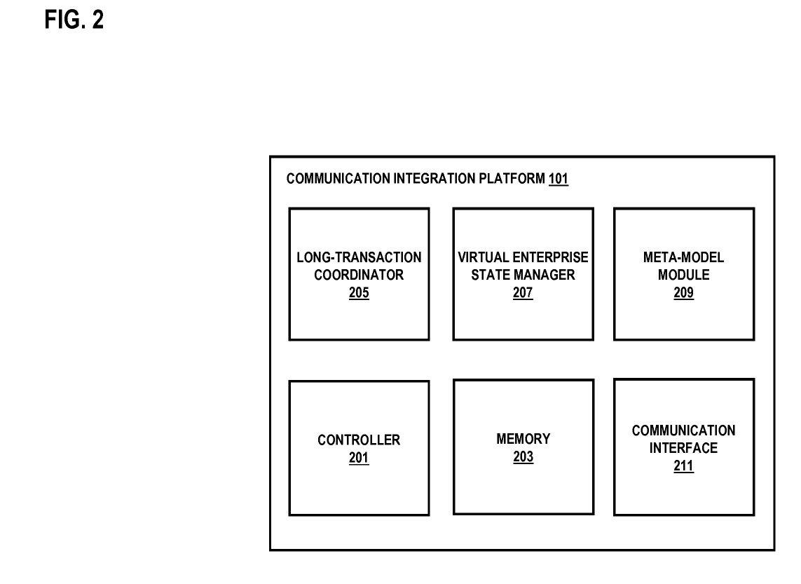

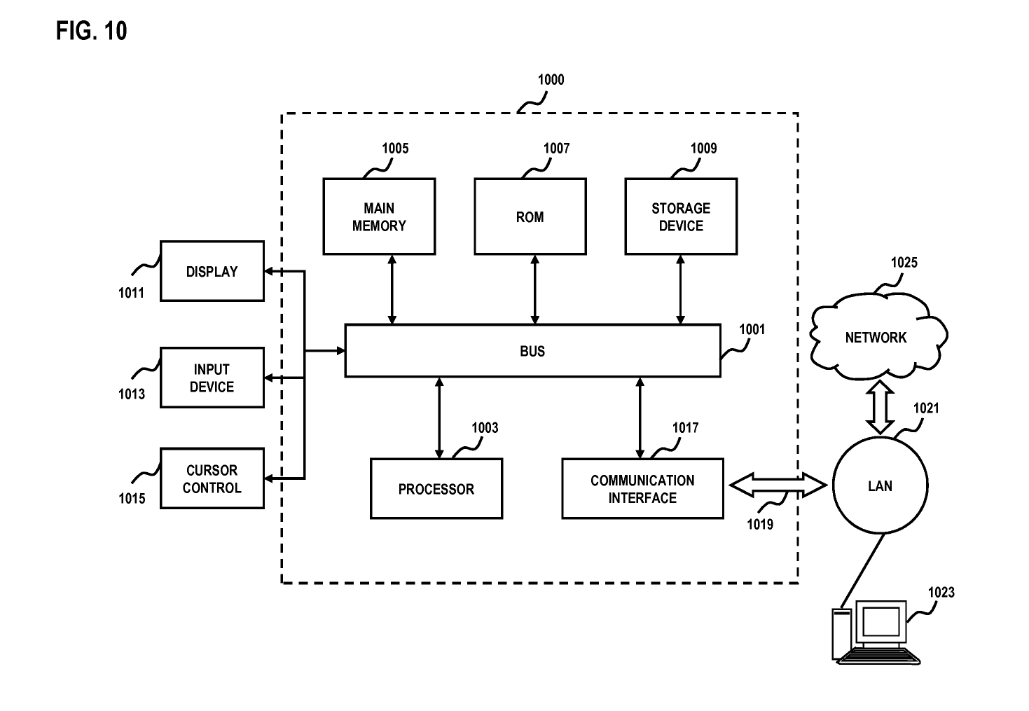

FIG. 2 is a diagram of the components of a communication integration platform, according to an exemplary embodiment. The communication integration platform 101 may comprise computing hardware (such as described with respect to FIG. 10), as well as include one or more components configured to execute the processes described herein for providing coded access services of the system 100. It is contemplated that the functions of these components may be combined in one or more components or performed by other components of equivalent functionality. In certain embodiments, the communication integration platform 101 includes a controller (or processor) 201, memory 203, a long-transaction coordinator 205, a virtual enterprise state manager 207, a meta-model module 209, and a communication interface 211.

The controller 201 may execute at least one algorithm for executing functions of the communication integration platform 101. For example, the controller 201 may interact with the long-transaction coordinator 205 to determine a request received from an originating resource manager (e.g., an event package). The request may, for instance, specify a product/service feature, declaration information, and an action to be performed on the feature. The long-transaction coordinator 205 may then merge contents of the request with a current state of the feature to generate, or update, a transaction in the transaction database 115. As mentioned, this event may, in turn, cause an update (e.g., by the virtual enterprise state manager 207) to the relevant portions of the profile database 117, such as the current state of the feature.

The controller 201 may also work with the meta-model module 209 to interpret the declaration information. As discussed, the declaration information may, for instance, include behavior declarations and/or structure declarations associated with the transaction and/or the feature. Thus, the meta-model module 209 may assess the declaration information to determine the meaning of the declared behaviors and structures. After such a determination, the long-transaction coordinator 205 may, for instance, decompose the request (e.g., a parent request) into child requests based on the declaration information (e.g., the declared behaviors and structures), and route the child requests to their respective destination resource managers based on the declaration information (e.g., via the communication interface 211).

Child responses from the destination resource managers may then be received in response to the child requests. The long-transaction coordinator 205 may, for instance, utilize the child responses to update the transaction in the transaction database 115. As indicated, the current state of the feature may be updated in the profile database 117 based on the updated transaction (e.g., by the virtual enterprise state manager 207). Additionally, or alternatively, the long-transaction coordinator 205 may generate a parent response based on the declaration information and the one or more child responses for transmission to the originating resource manager.

As mentioned, the controller 201 may further utilize the communication interface 211 to communicate with other components of the communication integration platform 101, the user devices 103, and other components of the system 100. The communication interface 211 may include multiple means of communication. For example, the communication interface 211 may be able to communicate over short message service (SMS), multimedia messaging service (MMS), internet protocol, instant messaging, voice sessions (e.g., via a phone network), email, or other types of communication. By way of example, such methods may be used to initiate transmission of child requests to their respective destination resource managers.

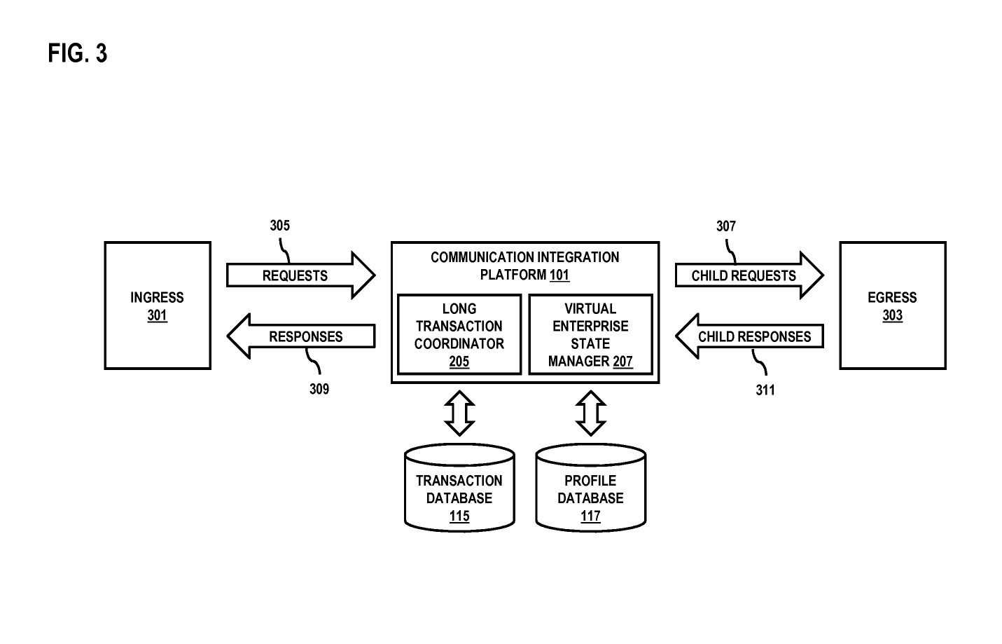

FIG. 3 is a diagram of interactions of a communication integration platform, according to an exemplary embodiment. As shown, in some embodiments, a request-oriented service architecture (ROSA) may be implemented based on a hub-and-spoke architecture model. In such an model, the communication integration platform 101 may, for instance, act as a facilitator (or the “hub”) for various external domains while one or more resource managers (or the “spokes”) provide the ingress and egress transforms (e.g., ingress 301 and egress 303) to the various external domains. Communications between the communication integration platform 101 and the resource managers (or other spoke endpoints) may, for instance, be performed by a canonical request/response protocol over a guaranteed delivery transport. As indicated, the long-transaction coordinator 205 and the virtual enterprise state manager 207 may work together to provide the current state of any request 305, child request 307, response 311, or child response 311 within a particular instance, or trusted group of instances, of a request-oriented architecture. It is noted that, in certain embodiments, the request-oriented service architecture may incorporate features from multiple systems and lines-of-business, and present them as one in a generic fashion (e.g., understood by the particular instance, the trusted group of instances, etc.).

In one embodiment, a request-orient service architecture moves the declaration (or definition) information (e.g., structural declarations, behavior declarations, etc., associated with a transaction, a feature, etc.) away from concrete system specification (e.g., web-services, UNIX-like daemons, window services, rule-engines or work-flow systems, etc.) to the request itself, which enables the request to “know” how to act within its own ROSA system or ROSA domain of systems. In other words, the request 305 may include declaration information that can be understood by a single ROSA instance or common/trusted ROSA instances/groups which share behavioral and structural definitions. However, an external (or untrusted) system may not understand, for instance, the definitions for the behaviors of another system.

In one scenario, an external application may send a traditional verb-noun request pattern to instigate a system-task. Once received at the ingress 301, a transform to the internal canonical form of that request may occur, forming, for instance, the request 305. This canonical form may contain both structure and behavior definitions, derived from the original verb-noun request. Thus, from the ingress point, the request 305 may be self-sufficient. That is, the request 305 may have its own life-cycle and the ability to traverse its environment in order to accomplish the task for which the request 305 was intended. In some embodiments, the request 305 may include the current state of the system and the concept library (and/or aspect dictionary) for the particular ROSA instance. As used herein, an “aspect” may define a programmable behavioral or structural concern, and a “concept” may refer to a language neutral operation or type that is utilized by various “aspect” definitions.

In a further scenario, the communication integration platform 101 may receive the request 305 from an originating resource manager (e.g., an event package configured to act as a compensating resource manager 119 at the ingress 301) and then merge the request 305 with a current state of the virtual enterprise to create, or modify, a long-transaction (e.g., a transaction that extends beyond the system domain, but not necessarily “long” in terms of time) that is stored, or updated, in the long-transaction database 115. As such, an update to the relevant portions of the profile database 117 may then be automatically initiated. In certain embodiments, the profile database 117 is not updated directly. Instead, the profile database 117 is updated by a transaction that is created, or modified, by requests (e.g., requests/responses 305, 307, 309, and 311).

Then, the communication integration platform 101 may decompose the requests 305 into child requests 307 (e.g., based on the behavior declarations in the request 305) and subsequently route the child requests 307 to their respective destinations (e.g., based on the behavior declarations). It is noted that spokes of a hub-and-spoke architecture may include the destination components, which may, for instance, be compensating resource managers (e.g., adapters of product/service features). It is also noted that, in some cases, the destination for the child requests 307 may be within the communication integration platform 101 (e.g., if the communication integration platform 101 is acting as the associated compensating resource manager), allowing for those child requests 307 to be further decomposed into grandchild requests for routing to their respective destinations.

In response to the routing of child requests 307, the communication integration platform 101 may receive child responses 311 from the destination components. The long-transaction coordinator 205 may then trigger an update to the associated transaction in the transaction database 115, which, in turn, may cause an update to the current state of the virtual enterprise. Based on the behavior declarations of the request 305 (e.g., the parent request), a response 309 may, for instance, be generated and sent to the originator of the request 305 (e.g., the event package configured to act as a compensating resource manager 119) once all of the child responses 311 are collected and analyzed. In various embodiments, the response 309 may, for instance, relate to the updated state of the virtual enterprise state.

In various embodiments, the difference between a request 305 and a transaction is that the request 305 may only include the minimal information necessary to create, or update, the transaction, but the transaction itself would use the current enterprise state and other requests 305 to provide the explicit action and status. Nonetheless, the schemas for a request 305 and a transaction may be identical even where their respective contents are different. In some embodiments, the schemas for the various requests and responses may also be the same even if, for instance, their respective actions may be different. As such, there may be no need for an explicit “request” or “response” type, since they may both just be variations of the “transaction” type.

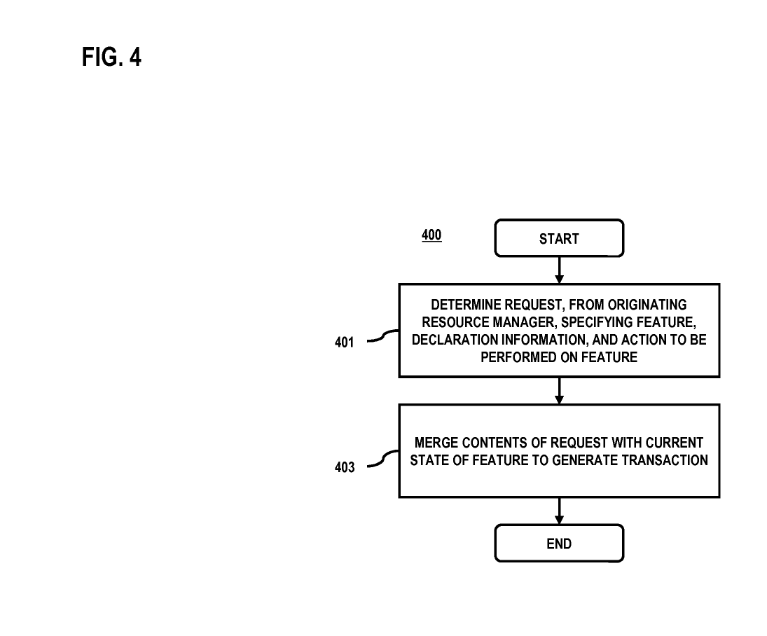

FIG. 4 is a flowchart of a process for providing a request-oriented service architecture, according to an exemplary embodiment. For the purpose of illustration, process 400 is described with respect to FIG. 1. It is noted that the steps of the process 400 may be performed in any suitable order, as well as combined or separated in any suitable manner. In step 401, the communication integration platform 101 may determine a request, from an originating resource manager, specifying a feature, declaration information, and an action to be performed on the feature. By way of example, the feature may be associated with a service, a product, or a combination thereof, and the feature (or an instance of the feature) may be stored in the profile database 117. Moreover, the declaration information may, for instance, include a behavior declaration, a structure declaration, or a combination thereof associated with the feature, a transaction, or a combination thereof.

In step 403, the communication integration platform 101 may merge contents of the request with a current state of the feature to generate the transaction, wherein the transaction is used to update the current state of the feature. In some embodiments, the transaction may be a long-transaction stored in the transaction database 115. The transaction may, for instance, specify the feature, the action to be performed on the feature, the current state of the feature, the declaration information, and a current status of the transaction. Additionally, or alternatively, the transaction may specify an intended state of the feature. As mentioned, in particular embodiments, the request may include the minimal information necessary to create, or update, the transaction. On the other hand, the transaction may be based on the request, the current state of the feature, and one or more other requests, for instance, to provide the explicit action and status.

It is noted that, in certain embodiments, the communication integration platform 101 may convert a request from an originator into an expanded transaction, provide transaction state coordination between the transaction database 115 and the profile database 117, instigate transaction decomposition, and instigate responses back to the originator. For illustrative purposes, specific details are provided with respect to various embodiments. By way of example, a transaction may be the combination of two entities: the profile and the request. The request may simply indicate the request and request-feature level change expectations, and the profile may provide the profile-feature level state. When a request is merged with the profile, both the current state and requested state may be combined to form the transaction. Example code may, for instance, include:

```
          <!-- Current Profile: -->
          <Profile>
          <Identifier>{301056C6}</Identifier>
            <ProfileFeatures>
              <ProfileFeature>
            <Identifier>{C7ADEE82}</Identifier>
            <Body>
            <Contact
              FirstName=“Bill”
              LastName=“Waters”/>
            </Body>
          </ProfileFeature>
          <ProfileFeature>
            <Identifier>{E7FC9EFB}</Identifier>
            <Body>
            <HomeAddress
              City=“Quogue”
              Street=“222 South Oak Street”
              State=“NY”
              ZipCode=“99288”/>
            </Body>
          </ProfileFeature>
          </ProfileFeatures>
        </Profile>
        <!-- Change Address Request: -->
        <Request>
          <Action>Begin</Action>
          <Profile>
          <Identifier>{301056C6}</Identifier>
          <ProfileFeatures>
            <ProfileFeature>
            <Action>Update</Action>
            <Identifier>{E7FC9EFB}</Identifier>
            <Body>
              <HomeAddress Street=“333 North Elm Street”/>
            </Body>
            </ProfileFeature>
          </ProfileFeatures>
          </Profile>
        </Request>
        <!-- Resulting Transaction: -->
        <Transaction>
          <Action>Begin</Action>
          <Profile>
          <Identifier>{301056C6}</Identifier>
          <ProfileFeatures>
            <ProfileFeature>
            <Action>Query</Action>
            <Identifier>{E7FC9EFB}</Identifier>
            <Body>
              <HomeAddress
              City=“Quogue”
              Street=“222 South Oak Street”
              State=“NY”
              ZipCode=“99288”/>
            </Body>
            </ProfileFeature>
            <ProfileFeature>
            <Action>Update</Action>
            <Identifier>{E7FC9EFB}</Identifier>
            <Body>
              <HomeAddress
              City=“Quogue”
              Street=“333 North Elm Street”
              State=“NY”
              ZipCode=“99288”/>
              <HomeAddress Street=“333 North Elm Street”/>
            </Body>
            </ProfileFeature>
          </ProfileFeatures>
          </Profile>
</Request>
```

Before the merge happens, it may be required that Identifiers (e.g., <Identifier>) be determined from Identities. Identifiers may, for instance, be the database primary key for a particular profile or profile feature, whereas, Identities may be unique fields within a request that can be used to determine the primary key of a particular profile or profile-feature. For example, a profile may have a profile-feature called a “customer subscriber number,” which could be used in a request in place of the profile Identifier. The pre-merge-task would know (e.g., coded into the request, based on a meta-model, etc.) that the Identity “customer subscriber number” is used to determine the Identifier for that customer profile. In this way, and in this example, the profile could contain many customers identified by a multitude of ways for the sake of a multitude of upstream or downstream systems.

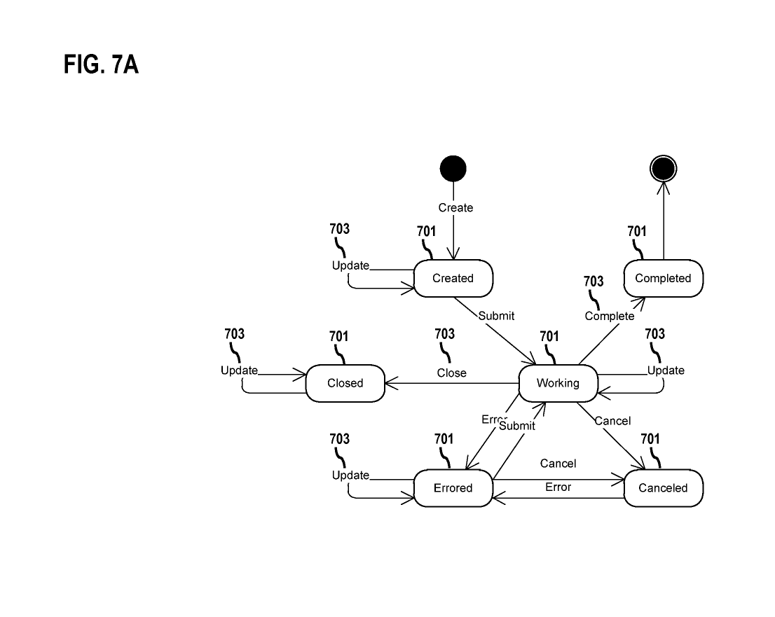

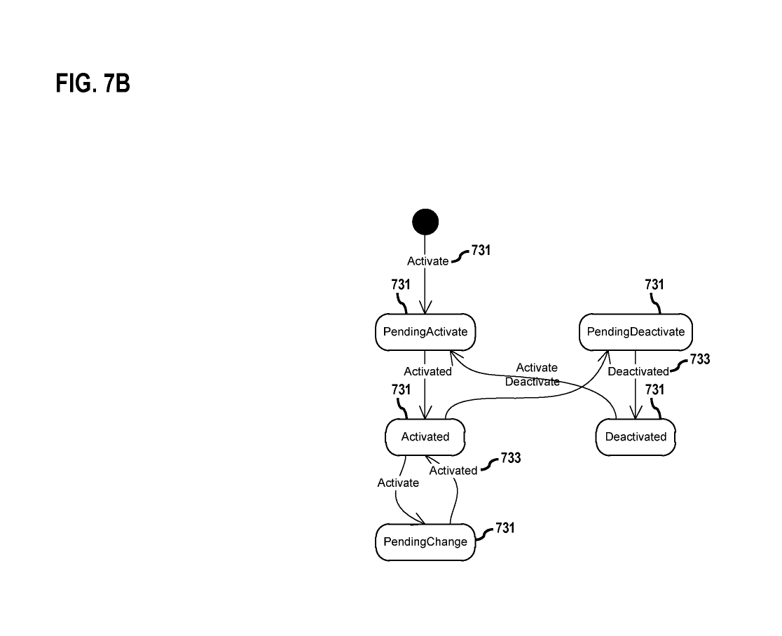

Moreover, in some embodiments, the communication integration platform 101 may coordinate changes to the profile database 117 using the transaction database 115. That is, the profile database 117 may not updated directly; instead, the profile database 117 may be updated by creating and executing a transaction. This task may also depend on the action that the transaction is requesting (e.g., Begin/Create, Submit, Complete/End, etc.) (see FIG. 7A). In one use case, a well-known optimistic locking mechanism may be used to synchronize changes to a single feature of any particular profile. A failure case may, for instance, only require re-merging of the feature. However, in cases where merging isn't be possible, a rollback may result.

In various embodiments, the communication integration platform 101 may instigate transaction decomposition into child requests. In addition, the communication integration platform 101 may correlate responses of child requests with a parent, update the parent transaction (and, thus, the associated profile) appropriately, and provide the final response to the origin of the parent request.

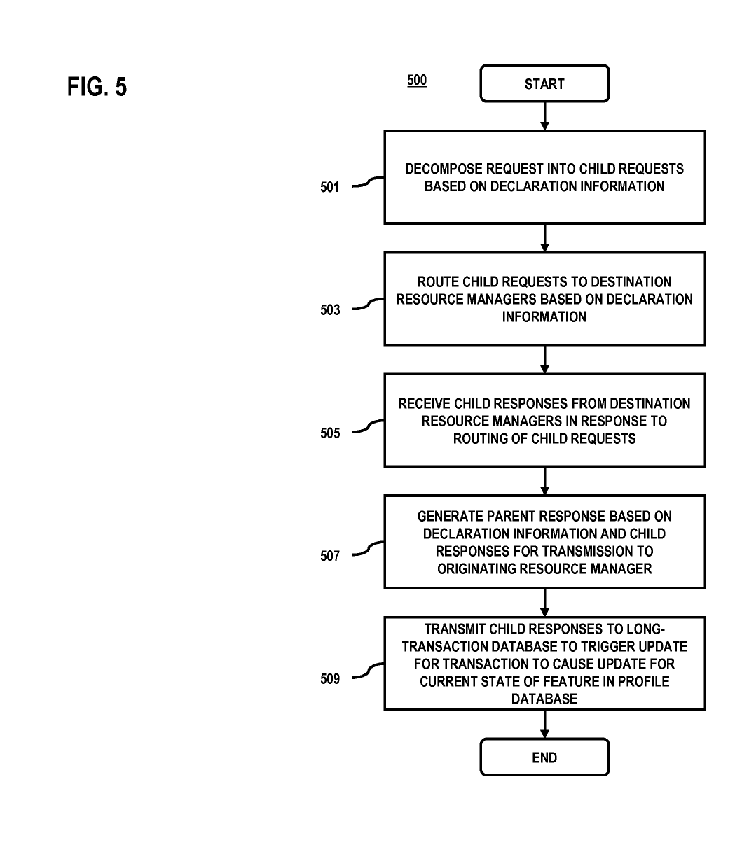

FIG. 5 is a flowchart of a process for updating a current state of a feature using a request-oriented service architecture, according to an exemplary embodiment. For the purpose of illustration, process 500 is described with respect to FIG. 1. It is noted that the steps of the process 500 may be performed in any suitable order, as well as combined or separated in any suitable manner. In step 501, the communication integration platform 101 may decompose the request into one or more child requests based on the declaration information, wherein the request is a parent request of the one or more child requests. The communication integration platform 101 may then, at step 503, route the one or more child requests to one or more destination resource managers based on the declaration information. As discussed, the declaration information may include behavior declarations and/or structure declarations for product/service features. Since the behaviors and the structures for a product/service feature are declared in the request, they may, for instance, be utilized by the communication integration platform 101 as a set of “instructions” for breaking down the request into corresponding child requests and for routing of the child requests to the destination resource managers to carry out respective parts of the request.

In step 505, the communication integration platform 101 may receive one or more child responses from the one or more destination resource managers in response to the routing of the one or more child requests. The communication integration platform 101 may also, at step 507, generate a parent response based on the declaration information and the one or more child responses for transmission to the originating resource manager. By way of example, each of the destination resource managers may carry out their respective child requests. Upon completion, the destination resource managers may each transmit the state “completed” in a child response to the communication integration platform 101. The communication integration platform 101 may collect and analyze all of the child responses and generate a collective parent response based on the declaration information (e.g., the behavior and/or structure declarations of the parent request) for transmission to the originating resource manager. In addition, in step 509, the communication integration platform 101 may transmit the one or more child responses to a long-transaction database to trigger an update for the transaction in the long-transaction database, wherein the current state of the feature is updated in the profile database based on the updated transaction.

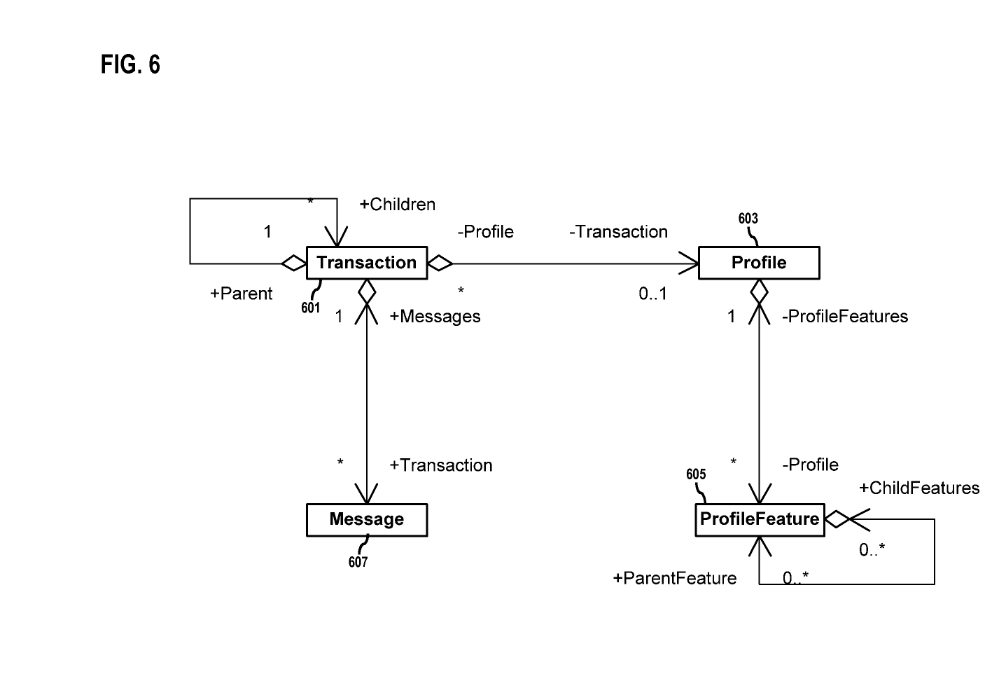

FIG. 6 is a diagram of a transaction database schema for a request-oriented service architecture, according to an exemplary embodiment. Specifically, FIG. 6 is a unified modeling language (UML) diagram for the transaction database schema, which, for instance, illustrates a transaction type 601, a profile type 603, a profile-feature type 605, and a message type 607. It is noted that, in various embodiments, a virtual enterprise state database schema may include the profile type 603 and the profile-feature type 605 (but not the transaction type 601). By way of example, the transaction type 601 may hold the transaction status and the action to be performed for a particular profile and its features. Moreover, the profile type 603 may hold the identity of the billable entity along with its features (of the profile-feature type 605), and the profile-feature type 605 may hold its current state and actions to be performed. In addition, the message type 607 may be associated with a transaction, for instance, to provide human-readable summaries and history of status information.

As mentioned, the transaction type 601 may be utilized for a request and a response (e.g., parent request 305, child request 307, parent response 309, child response 311, etc.). As shown, in this scenario, a parent request may be associated with (and decomposed into) many child requests, while a child request may only be derived from, or associated with, one parent request. In addition, as depicted, an element of the transaction type 601 may, for instance, specify up to one instance of the profile type 603 and its instances of the profile-feature type 605. However, in some cases, the particular instances of the profile type 603 and the profile-feature type 605 may be specified by more than one element of the transaction type 601 in the transaction database 115. As such, in certain embodiments, the transaction database 115 may allow for multiple instances of a single profile and its features. It is noted that, in some embodiments, differences between the transaction database schema and the virtual enterprise state database (or profile database) schema may exist. For example, the transaction database schema may hold a transaction element and allow for multiple instances of a single profile and its features. On the other hand, the virtual enterprise state database (or profile database) schema may not include the transaction element and may only allow for up to one instance of any particular profile and its various features. Nonetheless, despite potential schema differences, the transaction database 115 and the profile database (or virtual enterprise state database) 117 may, for instance, work together to provide the history of requested changes, the current status of changes occurring at any point in time, the current state of the enterprise at any point in time, etc.

FIGS. 7A and 7B are respectively diagrams of transaction states and profile feature states based on the occurrence of various actions, according to various exemplary embodiments. As shown, in FIG. 7A, the transaction state (e.g., any of the various states 701) may be changed based on an action (e.g., any of the various actions 703), for instance, in a request. For example, a transaction that is already “Created” may move from the “Created” state into a “Working” state when a “Submit” request action occurs. These actions can be generated externally (i.e., from outside the system) or internally (e.g., from a code-fabric event.) Similarly, in FIG. 7B, the profile feature state (e.g., any of the various states 731) may be changed based on an action (e.g., any of the various actions 733), for instance, in a request. For example, a feature may initially move into a “Pending-Activate” state when an “Activate” requested feature action occurs. These actions may, for instance, be provided with the request whose action provides context for the feature action (e.g., an error request with a “Deactivate” feature indicates that the feature change request failed).

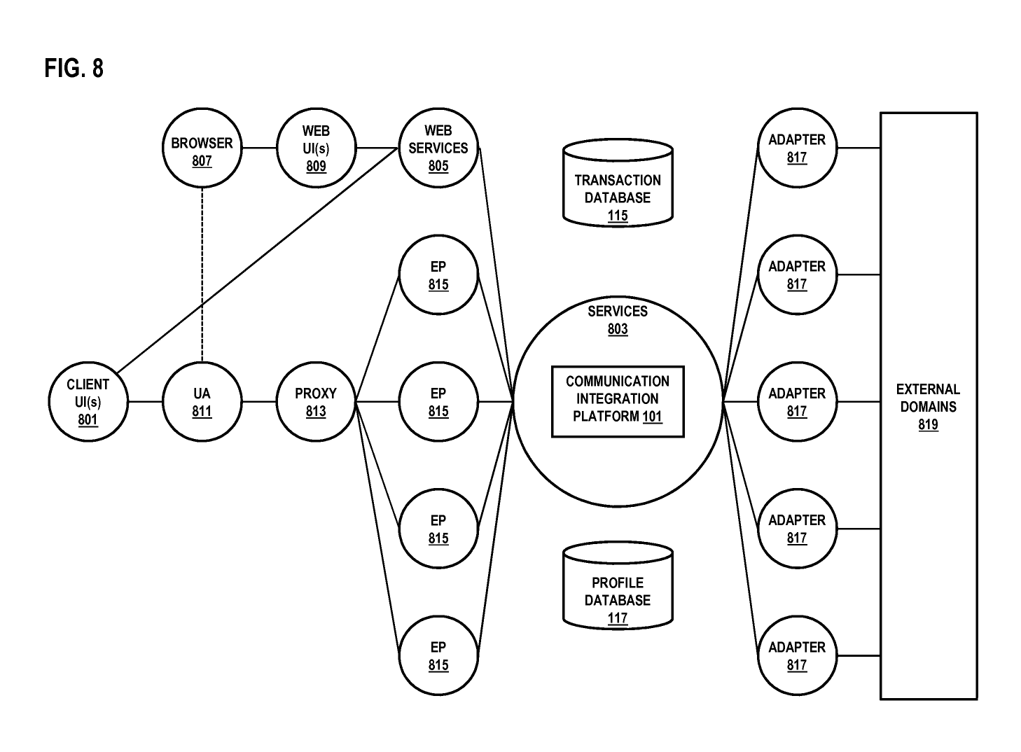

FIG. 8 is a diagram of various components that utilize a request-oriented service architecture, according to an exemplary embodiment. By way of example, an end-user may utilize a user device (e.g., user device 103) with a client user interface 801 to access services 803 provided through web services 805. The client user interface 801 may, for instance, utilize a browser 807 and a web user interface 809 (e.g., via a user agent 811) to initial requests (e.g., verb-noun requests) through the web service 805. Additionally, or alternatively, the client user interface 801 may access services 803 through the user agent 811 and proxy 813.

In one scenario, when a verb-noun request is received from the client user interface 801 at one of the event packages 815 (e.g., acting as an originating resource manager 119), the verb-noun request may be transformed into a request that specifies the service feature, actions to be performed with respect to the service feature, and behavior and/or structure declarations associated with the service feature (as well behavior and/or structure declarations associated with a corresponding transaction). The transformed request may then be transmitted from the event package 815 to the communication integration platform 101, which will merge contents of the request with a current state of the feature to generate (or updated) a transaction (e.g., a long-transaction). As indicated, the transaction may be stored in the transaction database 115.

Then, the transformed (or parent) request may be decomposed into one or more child requests based on the behavior and/or structure declarations and thereafter routed to one or more adapters 817 (e.g., acting as destination resource managers 119) based on the behavior and/or structure declarations. The adapters 817 may then process the child requests for their respective external domains 819 by converting the child requests into “instructions” for components of the external domains 819 that will implement various parts of the requested action. Upon notification by the components to the adapters 817 that the various parts of the requested action has been completed, the adapters 817 may each transmit a child response with the state “completed” to the communication integration platform 101. As discussed, the communication integration platform 101 may collect and analyze all of the child responses and generate a collective parent response based on the behavior and/or structure declarations of the parent request for transmission to the event package 815 from which the parent request originated. In addition, the communication integration platform 101 may transmit the child responses to the transaction database 115 to cause an update for the associated transaction. As a result, the current state of the feature may also be updated in the profile database based on the updated transaction. It is noted that although various embodiments are described with respect to requests flowing from external users to external domains, it is contemplated that the reverse may also be true. Thus, the approach described herein may similarly apply to requests flowing from external domains to external users (e.g., call status updates).

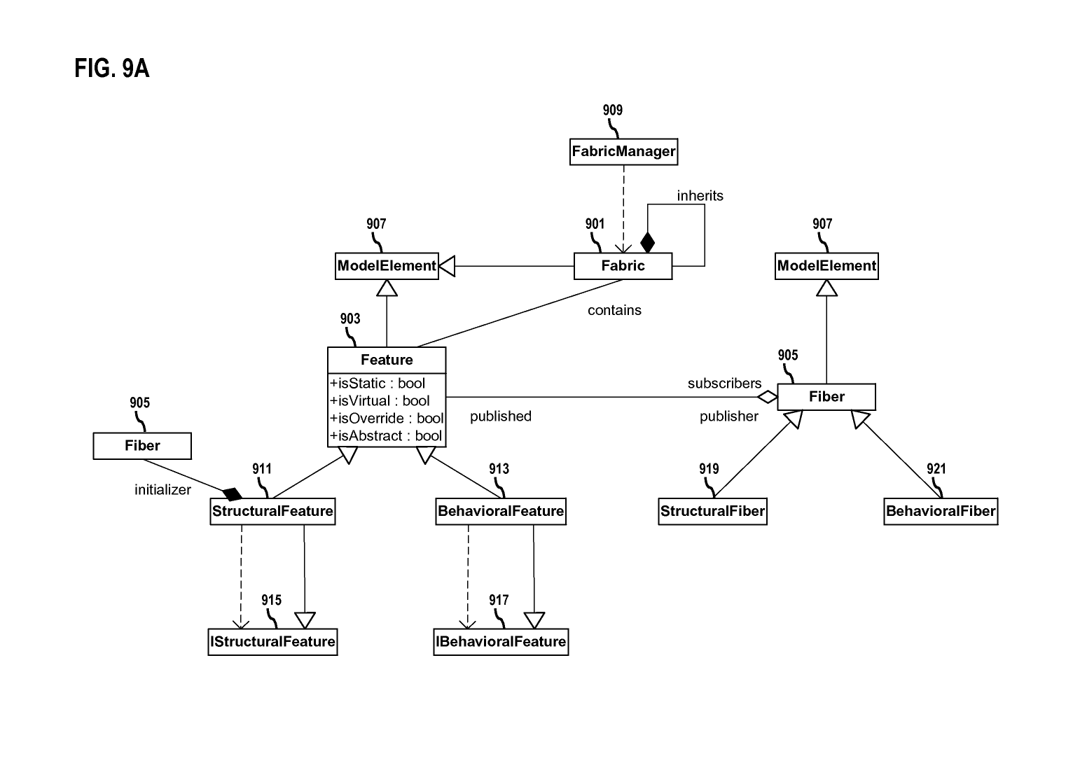

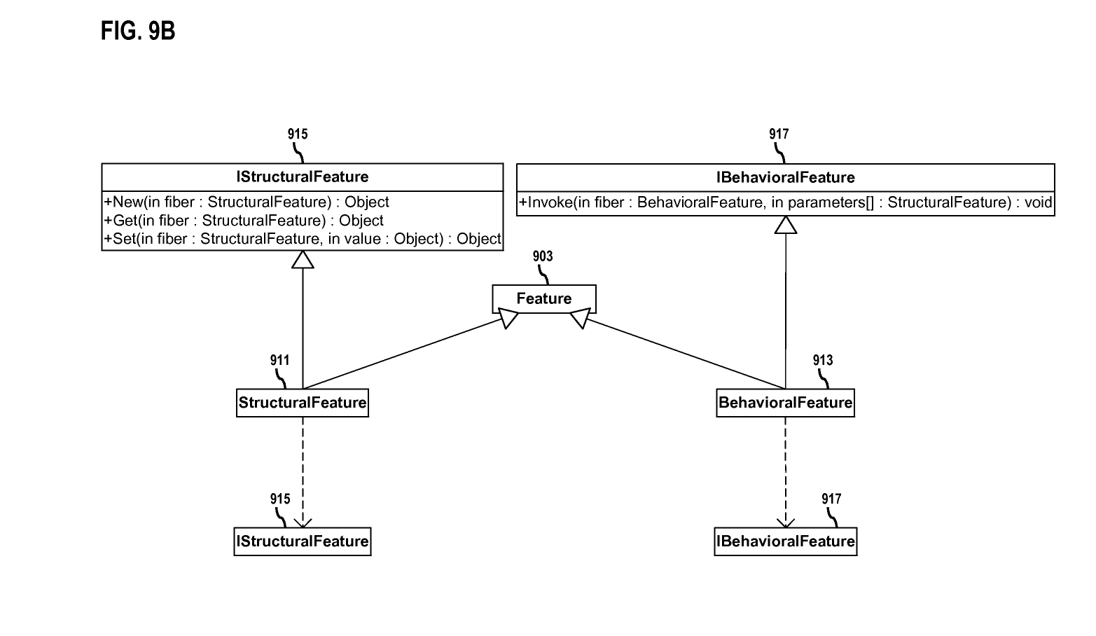

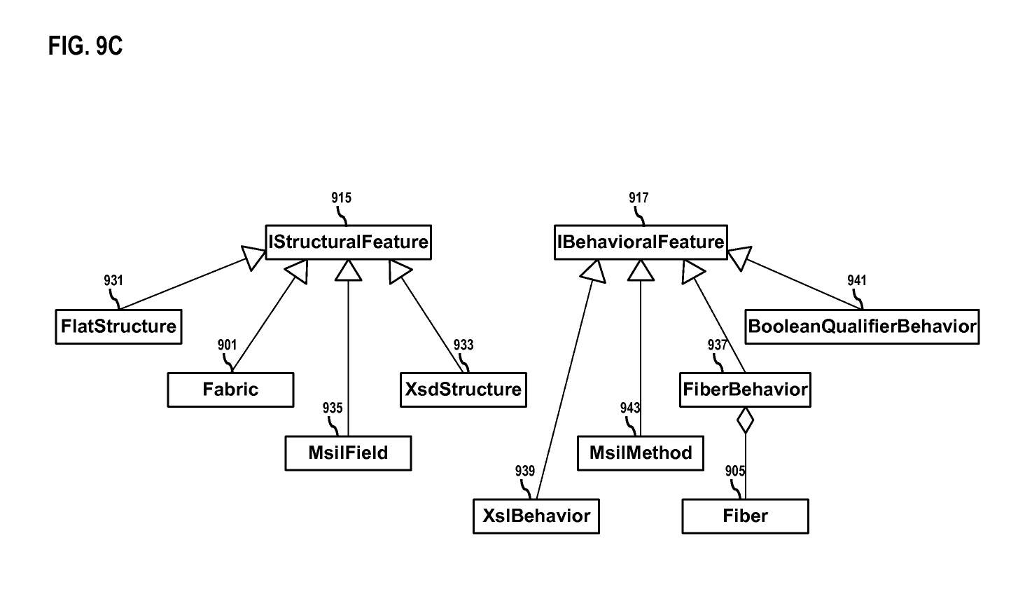

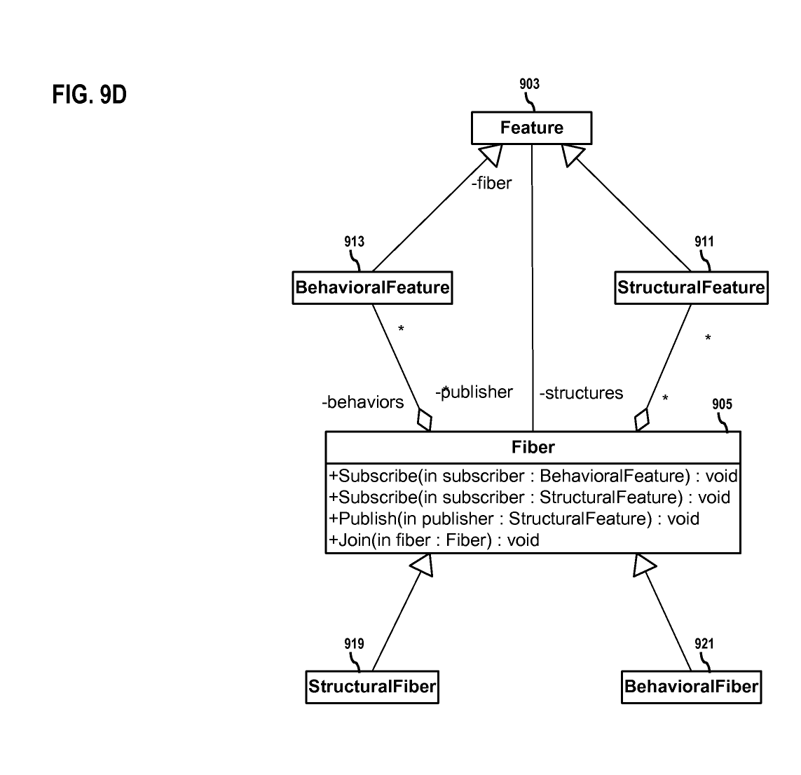

FIGS. 9A-9D are diagrams of components of a meta-model, according to various exemplary embodiments. For purposes of illustration, the meta-model may, for instance, be referred to as a Concept-Fabric Meta-Model (CFMM). The CFMM may, for instance, define a canonical form of the request, and how the request declares its behaviors and structures. It is noted that the CFMM may be an independent, agile software development tool that is able to store and reuse aspects (e.g., what it means to be a behavior or a structure) and concepts (e.g., language neutral operations or types). The CFMM may, for instance, enable architects and developers to reinterpret the meaning of each CFMM element to suit their respective purposes. In addition, the CFMM is an adaptable language that can tie (and retie) decoupled aspects together (e.g., aspects defined by the architecture and aspects used by the developer). In some embodiments, the CFMM may be based on a typical object-oriented meta-model (OOMM), but may also include explicit declarative data and control flow elements (e.g., Fiber) and abstracted feature elements. Nonetheless, equivalent OOMM statements or expressions may not exist in the CFMM unless such statements or expressions are created (e.g., by an architect or developer) as a new aspect.

As used herein, an “aspect” may define a programmable behavioral or structural concern, and a “concept” may refer to a language neutral operation or type that is utilized by various “aspect” definitions. As an example, the XSD (Extensible Markup Language (XML) Schema Definition) may be utilized in the concept library by a structural aspect definition provided by the aspect dictionary using a XPath query; that is, the concern is querying an XML document given an XSD by means of an XPath statement, the aspect dictionary provides the means to perform that query and the concept library defines the XML type definition. Further, other aspects could address other concerns regarding one particular concept, such as transformation, logging, security, etc. The combination may be described as an Aspect Dictionary and Concept Library, and may be accessed via web-services or other well-known network protocols. Aspects and concepts may, for instance, be version controlled and retained in a common database, accessible by the environment where a particular Fabric is active. By way of example, a Fabric of the CFMM may be a construct that is used as a blueprint to create instances of itself. In certain embodiments, users of the same Fabric repository (described below) may be able to reuse aspects once deployed. In this way, the CFMM may grow and be refined by the collective skill of the group, department, or enterprise.

As shown in the diagram of FIG. 9A, a Fabric 901 may be described by its feature set (e.g., Feature 903) and may participate in generalization and aggregation with other Fabric definitions. Fiber 905 may, for instance, be a type-safe function pointer that specifies a method to call and, in some embodiments, an element to call the method on. Moreover, Fibers 905 may be used to combine decoupled behavior and structure definitions together into a single Fabric 901 feature. As illustrated, Fiber 905 may be implemented using a Publish-Subscribe design pattern, so features are fired like events (e.g., they may be fired concurrently, one thread per subscriber). By way of example, a Publish-Subscribe design pattern may be described as a messaging pattern where senders of messages (called publishers) do not program the messages to be sent directly to specific receivers (called subscribers). Published messages may be characterized into categories, without knowledge of what, if any, subscribers there may be. Subscribers may express interest in one or more categories, and may only receive messages that are of interest, without knowledge of what, if any, publishers there are.

As illustrated, in this example, Fabric 901, Feature 903, and Fiber 905 inherit from ModelElement 907. Fabric 901 and FabricManager 909 are associated, but only FabricManager 909 knows of the association. In addition, StructuralFeature 911 and BehavioralFeature 913 inherit from Feature 903, and respectively inherit from IStructuralFeature 915 and IBehavioralFeature 917. Further, StructuralFiber 919 and BehavioralFiber 921 inherit from Fiber 905.

FIG. 9B further illustrates behavioral and structural features. By way of example, structural features may be features that contribute to the data element definition of the Fabric instance. Structural features may, for instance, include features such as references to documents, knowledge bases, primitive and complex field types, message formats, other structural collections, etc. On the other hand, behavioral features may define tasks of the Fabric instance. Behavioral features may, for instance, include features such as references to rules, security behaviors, execution of statements or expressions (e.g., “code-snippets”), logging behaviors, protocol adapters, other behavioral collections, etc. The Behavioral and Structural features may depend on their corresponding interface definitions to delegate the methods that they implement. Referring to FIG. 9B, an architect may implement IStructuralFeature 915 and/or IBehavioralFeature 917 when creating a new aspect definition. The IStructuralFeature 915 may, for instance, be implemented for data-centric aspects, and the IBehavioralFeature 917 may be implemented for control-centric aspects. For example, a common logger aspect may be implemented as an IBehavioralFeature 917, and a common log message may be implemented as an IStructuralFeature 915.

FIG. 9C illustrates examples of some concrete definitions that may be used and expanded upon, for instance, for use in a particular ROSA instance. It is noted, however, that these examples are not an exhaustive list of possibilities, but only a start point. With respect to structural features, Fabric aspect 901 is itself a structural feature. As such, a Fabric instance 901 can reference another Fabric instance 901 (e.g., aggregation). Additionally, or alternatively, a Fabric instance 901 can also derive from another Fabric instance 901 (e.g., generalization). Flat aspect 931 may, for instance, handle legacy data which is typically passed in a flat, positional, delimited, or mixed form. The Flat aspect 931 enables other behaviors and structures to access the details of these document types. The XsdStructure aspect 933 enables Fabric instances 901 to access the details of an XML document that conforms to a specific XSL Schema Definition (XSD). The MsilField aspect 935 enables a structure to be described using any .NET language (e.g., C#, VB, C++, etc.).

With respect to behavioral features, FiberBehavior aspect 937 enables Fabric instances 901 to describe data and control flow (e.g., using Fibers aspect 905) between previously decoupled features. XslBehavior aspect 939 provides a simple means to perform a transform on any structural feature. BooleanQualifierBehavior aspect 941 (or SimpleQualifier 941) provides a qualifier for most data and control flow. MsilMethod aspect 943 enables a behavior to be described using any .NET language (e.g., C#, VB, C++, etc.). Other behavioral features may, for instance, include logging and management aspects, learned behaviors, inference behaviors, and security aspects. In addition, in some cases, a feature itself may allow for contract enforcement using pre- and post-condition specifications. Moreover, it is noted that, in certain embodiments, it may be necessary to implement IStructuralFeature 915 and IBehavioralFeature 917 as one aspect, which may produce, for instance, hybrid features. For example, such hybrid features may be necessary in situations where the aspect is has both data and control exposed (e.g., an MSIL Class aspect that can hold an instance of .NET class written in any .NET language).

FIG. 9D further details the associations of the various components of the CFMM. As indicated, behavioral and structural fiber aspects (e.g., BehavioralFiber 921 and StructuralFiber 919) provide the CFMM the ability to associate control and data flow with behavioral and structural features (e.g., BehavioralFeature 913 and StructuralFeature 911). As mentioned, a Publish-Subscribe design pattern may be used to implement Fiber instances 905, and thus, behaviors may be event-driven, asynchronous, and distributed. A Feature 903 may, for instance, be a Fiber publisher or subscriber of data or control. In certain embodiments, and as shown in Table 1 below, Structural Features may subscribe to Structural Fibers (e.g., data flow) and Behavioral Features may subscribe to both Structural and Behavioral Fibers (e.g., data and control flow). In addition, in some cases, Structural Features may publish only data flow, but Behavioral Features may publish both data and control flow.

TABLE 1

```
Fiber Structural Publisher
          Fiber Structural Subscriber: Data Flow
          Fiber Behavioral Subscriber: Data Flow
Fiber Behavioral Publisher
          Fiber Structural Subscriber: Data Flow
          Fiber Behavioral Subscriber: Control Flow
```

For purposes of illustration, example code based on ROSA and CFMM, according to one exemplary embodiment, is provided below:

```
        <?xml version=“1.0” encoding=“utf-8” ?>
        <ModelManager>
```

| <!-- THIS IS THE COLLECTION OF EXPLICIT DECLARATIONS FOR A | | --> |
|---|---|---|
| <!-- SPECIFIC MODEL-ENVELOPE (SHOWN BELOW) | | --> |
| <!-- (1) | NOTE THAT THE SIMILARITY TO MICROSOFT CODEDOM | --> |
| <!-- | SCHEMA IS PURPOSEFUL, IT ALLOWS FOR EASY | --> |
| <!-- | IMPLEMENTATION OF COMPILATION AND LANGUAGE | --> |
| <!-- | CONVERSION | --> |

```
          <ModelCompileUnit>
            <ModelNamespaces>
```

| | |
|---|---|
| <!-- THE CONVERGENCE ‘TRANSACTION’ NAMESPACE | --> |
| <!-- DECLARATION | --> |

```
              <ModelNamespace Name=“Vz.Convergence.Transaction”>
                <ModelElements>
```

| <!-- DECLARE FIBER(S) FOR CONTROL AND DATA-FLOW | | --> |
|---|---|---|
| <!-- FROM THE PUBLISHER TO THE SUBSCRIBER(S) | | --> |
| <!-- WHICH ARE FIRED DURING GET, SET OR INVOKE OF | | --> |
| <!-- THE PUBLISHER (WHICH IN THIS CASE, IS | | --> |
| <!-- A GENERIC RECEIVER PORT FOR THE CONVERGENCE | | --> |
| <!-- ARCHITECTURE.) | | --> |
| <!-- (1) | THIS DECLARATION WOULD BUILD ON ALREADY | --> |
| <!-- | DEFINED FIBERS (IF ANY), SO | --> |
| <!-- | IT SHOULDN'T BE CONSIDERED AN EXHAUSTIVE | --> |
| <!-- | LIST OF FIBERS | --> |
| <!-- (2) | THE FABRIC-CONCEPT CALLED FIBER-BOOTSTRAP | --> |
| <!-- | IS A SPECIAL ASPECT OF THE CFMM RUNTIME, | --> |
| <!-- | ALLOWING FIBERS TO BE FIRED DURING TYPE | --> |
| <!-- | EVALUATION | --> |
| <!-- (3) | THE FABRIC-CONCEPT STATIC-METHOD AND | --> |
| <!-- | TYPE-REFERENCE ARE SPECIAL MSIL LANGUAGE | --> |
| <!-- | ASPECTS, MAKING IT EASY TO USE WITHIN THE | --> |
| <!-- | .NET ARCHITECTURE | --> |

```
                  <BehavioralFiber Name=“BootstrapControlFlow, 1.0”>
                    <Publisher
        Model=“Vz.ConceptFabric.Runtime.ConceptFabricConcept.FabricConceptFiberBootstrap,
        1.0” Module=“Vz.Convergence.Receiver,
        1.0”>Main</Publisher>
                    <Subscribers>
                      <Subscriber
        Model=“Vz.ConceptFabric.Runtime.ConceptFabricConcept.FabricConceptTypeReference,
        1.0” Module=“Vz.Convergence.Transaction.Transaction,
        1.0”>Action</Subscriber>
                    </Subscribers>
                  </BehavioralFiber>
```

| | |
|---|---|
| <!-- DECLARE THE TRANSACTION FABRIC AND ITS | --> |
| <!-- ASSOCIATED MESSAGE FABRIC | --> |

```
                  <Fabric Name=“Transaction, 1.0”>
                    <Features>
                      <BehavioralFeature Name=“Action”
        Model=“Vz.ConceptFabric.Runtime.ConceptFabricConcept.FabricConceptTypeMemberStaticMethod,
        1.0” Module=“Vz.Convergence.Transaction.Action,
        1.0” />
                      <StructuralFeature Name=“Parent”
        Model=“Vz.ConceptFabric.Runtime.ConceptFabricConcept.FabricConceptTypeReference,
        1.0” Module=“Vz.Convergence.Transaction, 1.0” />
                      <StructuralFeature Name=“Children”
        Model=“Vz.ConceptFabric.Runtime.ConceptFabricConcept.FabricConceptTypeReference,
        1.0” Module=“Vz.Convergence.List, 1.0” />
                      <StructuralFeature Name=“Messages”
        Model=“Vz.ConceptFabric.Runtime.ConceptFabricConcept.FabricConceptTypeReference,
        1.0” Module=“Vz.Convergence.List, 1.0” />
                      <StructuralFeature Name=“Profile”
        Model=“Vz.ConceptFabric.Runtime.ConceptFabricConcept.FabricConceptTypeReference,
        1.0” Module=“Vz.Convergence.Profile.Profile, 1.0” />
                    </Features>
                  </Fabric>
                  <Fabric Name=“Message, 1.0”>
                    <Features>
                      <StructuralFeature Name=“Kind”
        Model=“Vz.ConceptFabric.Runtime.ConceptFabricConcept.FabricConceptTypeReference,
        1.0” Module=“Vz.Convergence.Int, 1.0” />
                      <StructuralFeature Name=“Level”
        Model=“Vz.ConceptFabric.Runtime.ConceptFabricConcept.FabricConceptTypeReference,
        1.0” Module=“Vz.Convergence.Int, 1.0” />
                      <StructuralFeature Name=“Identifier”
        Model=“Vz.ConceptFabric.Runtime.ConceptFabricConcept.FabricConceptTypeReference,
        1.0” Module=“Vz.Convergence.Int, 1.0” />
                      <StructuralFeature Name=“Detail”
        Model=“Vz.ConceptFabric.Runtime.ConceptFabricConcept.FabricConceptTypeReference,
        1.0” Module=“Vz.Convergence.String, 1.0” />
                    </Features>
                  </Fabric>
```

| | |
|---|---|
| <!-- (OPTIONALLY) DECLARE THE REPOSITORY LIBRARY | --> |
| <!-- AND ITS MODULE (IN THIS CASE USING C#, | --> |
| <!-- BUT IT COULD BE ANY ‘LANGUAGE’ THAT IS | --> |
| <!-- DEFINED BY THE ASPECT ‘MODEL’) | --> |

```
                  <Repository Name=“Transaction, 1.0”>
                    <Modules>
                      <Module Name=“Action, 1.0”
        Model=“Vz.ConceptFabric.Runtime.ConceptFabricConcept.FabricConceptTypeMemberStaticMethod,
        1.0” >
                        <![CDATA[
                          // Notice that the method name doesn't have to
                          // match the module name. It takes a transaction
                          // and returns the same (which it didn't have too,
                          // but for the sake of another fiber in the future)
                          public static
        Vz.Convergence.Transaction.Transaction MyActionImplementation(
        Vz.Convergence.Transaction.Transaction transaction )
                          {
                            // custom software that will act on transaction
                            // action... this action is fired when the
                            // Vz.Convergence.Receiver.Main method returns
                            return transaction;
                          }
                        ]]>
                      </Module>
                    </Modules>
                  </Repository>
                </ModelElements>
              </ModelNamespace>
```

| | |
|---|---|
| <!-- THE CONVERGENCE ‘PROFILE’ NAMESPACE DECLARATION | --> |
| <ModelNamespace Name=“Vz.Convergence.Profile”> | |
| <ModelElements> | |

| | |
|---|---|
| <!-- FIBERS AREN'T ALWAYS NECESSARY, SUCH AS IN | --> |
| <!-- THIS CASE | --> |
| <!-- DECLARE THE PROFILE FABRIC AND ASSOCIATED | --> |
| <!-- PROFILE-FEATURE FABRIC | --> |

```
                  <Fabric Name=“Profile, 1.0”>
                    <Features>
                      <StructuralFeature Name=“Identifier”
        Model=“Vz.ConceptFabric.Runtime.ConceptFabricConcept.FabricConceptTypeReference,
        1.0” Module=“Vz.Convergence.Guid, 1.0” />
                      <StructuralFeature Name=“ProfileFeatures”
        Model=“Vz.ConceptFabric.Runtime.ConceptFabricConcept.FabricConceptTypeReference,
        1.0” Module=“Vz.Convergence.List, 1.0” />
                    </Features>
                  </Fabric>
                  <Fabric Name=“ProfileFeature, 1.0”>
                    <Features>
                      <BehavioralFeature Name=“Action”
        Model=“Vz.ConceptFabric.Runtime.ConceptFabricConcept.FabricConceptTypeReference,
        1.0” Module=“Vz.Convergence.List, 1.0” />
                      <StructuralFeature Name=“Identifier”
        Model=“Vz.ConceptFabric.Runtime.ConceptFabricConcept.FabricConceptTypeReference,
        1.0” Module=“Vz.Convergence.Guid, 1.0” />
                      <StructuralFeature Name=“Parent”
        Model=“Vz.ConceptFabric.Runtime.ConceptFabricConcept.FabricConceptTypeReference,
        1.0” Module=“Vz.Convergence.Profile.ProfileFeature, 1.0”
        />
                      <StructuralFeature Name=“Children”
        Model=“Vz.ConceptFabric.Runtime.ConceptFabricConcept.FabricConceptTypeReference,
        1.0” Module=“Vz.Convergence.List, 1.0” />
                      <StructuralFeature Name=“Body”
        Model=“Vz.ConceptFabric.Runtime.ConceptFabricConcept.FabricConceptTypeReference,
        1.0” Module=“Vz.Convergence, 1.0” />
                    </Features>
                  </Fabric>
                </ModelElements>
              </ModelNamespace>
            </ModelNamespaces>
          </ModelCompileUnit>
```

| <!-- THE ACTUAL TRANSACTION INSTANCE IS SEPARATE FROM THE | | --> |
|---|---|---|
| <!-- DECLARATION (ABOVE) | | --> |
| <!-- (1) | NOTE THAT THE REFERENCE TO THE FABRIC TYPE CAN BE | --> |
| <!-- | IMPLICIT (AS IT IS HERE) OR EXPLICIT | --> |
| <!-- | BY USING A MODULE REFERENCE | --> |
| <!-- (2) | GIVEN (1), THE MODEL-COMPILE-UNIT SECTION ABOVE | --> |
| <!-- | ISN'T NECESSARY (ESP. FOR EXTERNAL INTERFACES) | --> |
| <!-- | BUT INSTEAD, IT WOULD MAINLY BE USED FOR INTERNAL | --> |
| <!-- | MESSAGING | --> |

```
          <ModelEnvelope>
            <Vz.Convergence.Transaction.Transaction>
        <Vz.Convergence.Transaction.Transaction.Action>Create</Vz.Convergence.-
        Transaction.Transaction.Action>
              <Vz.Convergence.Transaction.Transaction.Profile>
                <Vz.Convergence.Profile.Profile>
                  <Vz.Convergence.Profile.Profile.Identifier>{301056C6-640D-
        4E5B-BB25-57427361ABAD}</Vz.Convergence.Profile.Profile.Identifier>
                  <Vz.Convergence.Profile.Profile.ProfileFeatures>
                    <Vz.Convergence.Profile.ProfileFeature>
        <Vz.Convergence.Profile.ProfileFeature.Action>Update</Vz.Convergence.-
        Profile.ProfileFeature.Action>
        <Vz.Convergence.Profile.ProfileFeature.Identifier>{E7FC9EFB-587B-
        4273-A922-
        3848AEF12083}</Vz.Convergence.Profile.ProfileFeature.Identifier>
                      <Vz.Convergence.Profile.ProfileFeature.Body>
                        <Vz.Convergence.Profile.ProfileFeature.Call
        Action=“Hold” Identifier=“sip:callappearance-001@localhost-9929”/>
                      </Vz.Convergence.Profile.ProfileFeature.Body>
                    </Vz.Convergence.Profile.ProfileFeature>
                  </Vz.Convergence.Profile.Profile.ProfileFeatures>
                </Vz.Convergence.Profile.Profile>
              </Vz.Convergence.Transaction.Transaction.Profile>
            </Vz.Convergence.Transaction.Transaction>
          </ModelEnvelope>
</ModelManager>
```

The processes described herein for providing a request-oriented service architecture may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 10 is a diagram of a computer system that can be used to implement various exemplary embodiments. The computer system 1000 includes a bus 1001 or other communication mechanism for communicating information and one or more processors (of which one is shown) 1003 coupled to the bus 1001 for processing information. The computer system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computer system 1000 may further include a read only memory (ROM) 1007 or other static storage device coupled to the bus 1001 for storing static information and instructions for the processor 1003. A storage device 1009, such as a magnetic disk, flash storage, or optical disk, is coupled to the bus 1001 for persistently storing information and instructions.

The computer system 1000 may be coupled via the bus 1001 to a display 1011, such as a cathode ray tube (CRT), liquid crystal display, active matrix display, or plasma display, for displaying information to a computer user. Additional output mechanisms may include haptics, audio, video, etc. An input device 1013, such as a keyboard including alphanumeric and other keys, is coupled to the bus 1001 for communicating information and command selections to the processor 1003. Another type of user input device is a cursor control 1015, such as a mouse, a trackball, touch screen, or cursor direction keys, for communicating direction information and command selections to the processor 1003 and for adjusting cursor movement on the display 1011.

According to an embodiment of the invention, the processes described herein are performed by the computer system 1000, in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the invention. Thus, embodiments of the invention are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, communication interface 1017 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 10, multiple communication interfaces can also be employed.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an embodiment of the invention through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

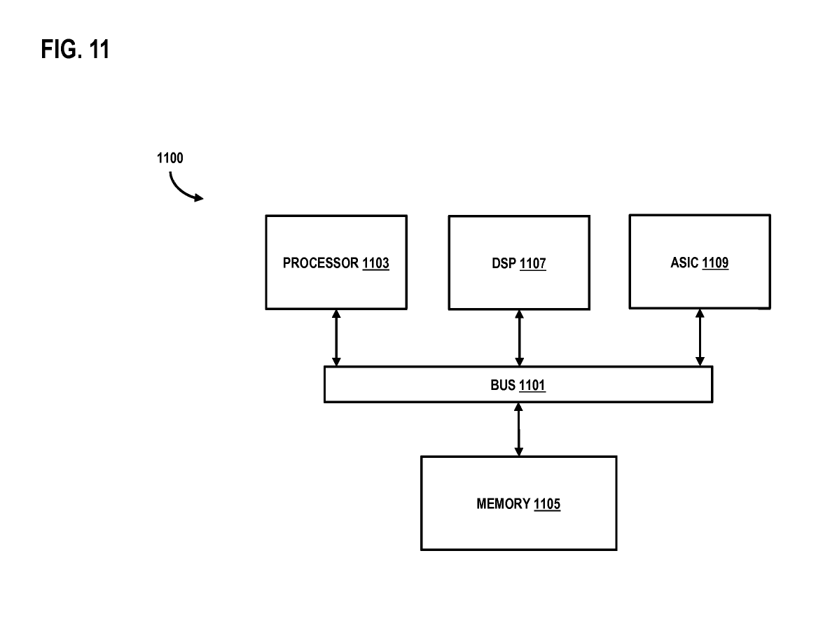

FIG. 11 illustrates a chip set or chip 1100 upon which an embodiment of the invention may be implemented. Chip set 1100 is programmed to enable a request-oriented service architecture as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of enabling a request-oriented service architecture.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to enable a request-oriented service architecture. The memory 1105 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
determining a request, from an originating resource manager, specifying a feature, declaration information, and an action to be performed on the feature; and
merging contents of the request with a current state of the feature to generate a transaction,
wherein the transaction is used to update the current state of the feature.

2. A method according to claim 1, wherein the feature is associated with a service, a product, or a combination thereof, and the declaration information includes a behavior declaration, a structure declaration, or a combination thereof associated with the transaction, the feature, or a combination thereof.

3. A method according to claim 1, wherein the transaction specifies an intended state of the feature.

4. A method according to claim 1, further comprising:
decomposing the request into one or more child requests based on the declaration information, wherein the request is a parent request of the one or more child requests; and
routing the one or more child requests to one or more destination resource managers based on the declaration information.

5. A method according to claim 4, further comprising:
receiving one or more child responses from the one or more destination resource managers in response to the routing of the one or more child requests; and
generating a parent response based on the declaration information and the one or more child responses for transmission to the originating resource manager.

6. A method according to claim 5, further comprising:
transmitting the one or more child responses to a long-transaction database to trigger an update for the transaction in the long-transaction database,
wherein the current state of the feature is updated in a profile database based on the updated transaction.

7. A method according to claim 4, wherein the originating resource manager and the one or more destination resource managers are spokes of a hub-and-spoke-architecture.

8. A method according to claim 1, wherein the transaction is based on the request, the current state of the feature, and one or more other requests.

9. An apparatus comprising:
at least one processor; and
at least one memory including computer program code for one or more programs,
the at least one memory and the computer program code configured to, with the at least one processor, cause the apparatus to perform at least the following,
determine a request, from an originating resource manager, specifying a feature, declaration information, and an action to be performed on the feature; and
merge contents of the request with a current state of the feature to generate a transaction,
wherein the transaction is used to update the current state of the feature.

10. An apparatus according to claim 9, wherein the feature is associated with a service, a product, or a combination thereof, and the declaration information includes a behavior declaration, a structure declaration, or a combination thereof associated with the transaction, the feature, or a combination thereof.

11. An apparatus according to claim 9, wherein the transaction specifies an intended state of the feature.

12. An apparatus according to claim 9, wherein the apparatus is further caused to:
decompose the request into one or more child requests based on the declaration information, wherein the request is a parent request of the one or more child requests; and
route the one or more child requests to one or more destination resource managers based on the declaration information.

13. An apparatus according to claim 12, wherein the apparatus is further caused to:
receive one or more child responses from the one or more destination resource managers in response to the routing of the one or more child requests; and
generate a parent response based on the declaration information and the one or more child responses for transmission to the originating resource manager.

14. An apparatus according to claim 13, wherein the apparatus is further caused to:
transmit the one or more child responses to a long-transaction database to trigger an update for the transaction in the long-transaction database,
wherein the current state of the feature is updated in a profile database based on the updated transaction.

15. An apparatus according to claim 12, wherein the originating resource manager and the one or more destination resource managers are spokes of a hub-and-spoke-architecture.

16. An apparatus according to claim 9, wherein the transaction is based on the request, the current state of the feature, and one or more other requests.

17. A system comprising:
a communication integration platform configured to determine a request, from an originating resource manager, specifying a feature, declaration information, and an action to be performed on the feature, and merge contents of the request with a current state of the feature to generate a transaction,
wherein the transaction is used to update the current state of the feature.

18. A system according to claim 17, wherein the feature is associated with a service, a product, or a combination thereof, and the declaration information includes a behavior declaration, a structure declaration, or a combination thereof associated with the transaction, the feature, or a combination thereof.

19. A system according to claim 17, wherein the communication integration platform is further configured to:
decompose the request into one or more child requests based on the declaration information, wherein the request is a parent request of the one or more child requests; and
route the one or more child requests to one or more destination resource managers based on the declaration information.

20. A system according to claim 17, wherein the communication integration platform is further configured to:
receive one or more child responses from the one or more destination resource managers in response to the routing of the one or more child requests;
generate a parent response based on the declaration information and the one or more child responses for transmission to the originating resource manager; and
transmit the one or more child responses to a long-transaction database to trigger an update for the transaction in the long-transaction database,
wherein the current state of the feature is updated in a profile database based on the updated transaction.
